(19) United States
(12) Patent Application Publication
(10) Pub. No.: US 2005/0040956 A1
(43) Pub. Date: Feb. 24, 2005

(54) Separation alert system

(76) Inventors: Steven R. Allen, Crowley, TX (US); Rebecca L. Allen, Crowley, TX (US)

Correspondence Address: Michael A. O'Neil;Michael A. O'Neil, P.C., Suite 820, 5949 Sherry Lane, Dallas, TX, 75225, US

(21) Appl. No.: 10/909,626

(22) Filed: Aug. 2, 2004

Related U.S. Application Data
(60) Provisional application No. 60/492,533, filed on Aug. 5, 2003.

(51) Int. Cl. G08B 23/00

(52) U.S. Cl. 340/573.4

(57) ABSTRACT

A separation alert system includes a first component securable to a child, an elderly or disabled person, or an animal. A second component is securable to a person having responsibility for the child, the elderly or disabled person, or the animal. The second component includes an alarm which is activated whenever the second component is separated from the first component by more than a predetermined distance.

### TECHNICAL FIELD

This invention relates generally to the protection of children, elderly and disabled persons, and animals, and more particularly to a system for sounding an alarm whenever a person providing supervision for children, elderly or disabled persons, or animals is separated by a more than a predetermined distance from an individual child, elderly or disabled person, or animal being supervised.

### BACKGROUND AND SUMMARY OF THE INVENTION

As is well known, children are frequently injured or killed as a result of being left in vehicles while the responsible adult runs an errand, etc. A related but usually less tragic problem involves the separation of children from the responsible person during shopping or recreational activities either because the child is hiding or because the child is simply lost. Similar problems arise when elderly or disabled persons wander away from a supervised location. Yet another related problem is the unintended separation of animals from their owners during hunting and other activities.

The present invention addresses the foregoing and similar problems which have long since characterized the prior art. In accordance with the broader aspects of the invention, an alarm is sounded whenever a child, an elderly or disabled person, or an animal is separated from the responsible person by more than a predetermined distance. For example, if a child is left in a vehicle when the responsible person leaves the vehicle to run an errand, etc. an alarm sounds. If a child is separated from the responsible person by more than a predetermined distance during a shopping or recreational activities, an alarm sounds. If an elderly or disabled person wanders away from a supervised area, an alarm sounds. If an animal wanders away from its master during hunting or other activities, an alarm sounds.

In accordance with more specific aspects of the invention, a first component of the system of the present invention is secured to a child, an elderly or disabled person, a pet or other animal, etc. In the case of an infant, the first component may be secured to a car seat or similar device in which the child is secured. In the case of older children and elderly or disabled persons, the first component is secured to a clothing item worn by the individual. In the case of a pet or other animal, the first component is secured to a collar or harness worn by the animal.

A second component of the system of the present invention is secured to the person, typically an adult, that is responsible for the safety of the child, the elderly or disabled person, or the animal to which the first component is secured. Whenever the first and second components of the system are separated by more than a predetermined distance, the second component of the system is activated to generate a alarm which may audible, visible, or both. The alarm may also have a vibration mode similar to that employed in many mobile phones. Preferably, the amount of separation between the first and second components of the system which is sufficient to activate the alarm is adjustable thereby preventing actuation of the alarm except in case of a genuine emergency.

In accordance with another aspect of the invention, a plurality of first components of the system is provided. Each of the first components of the system is tuned to a different frequency. An individual second component of the system is adapted for actuation whenever it is separated by more than a predetermined distance from any of the first components of the system. In this manner a single responsible adult is able to provide supervision for a plurality of children, a plurality of elderly or disabled persons, a plurality of pets or other animals, etc.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of a first utilization of the invention;

FIG. 2 is a diagrammatic illustration of a second utilization of the invention;

FIG. 3 is a diagrammatic illustration of a third utilization of the invention;

FIG. 4 is a diagrammatic illustration of a fourth utilization of the invention; and

FIG. 5 is a diagrammatic illustration of a fifth utilization of the invention.

### DETAILED DESCRIPTION

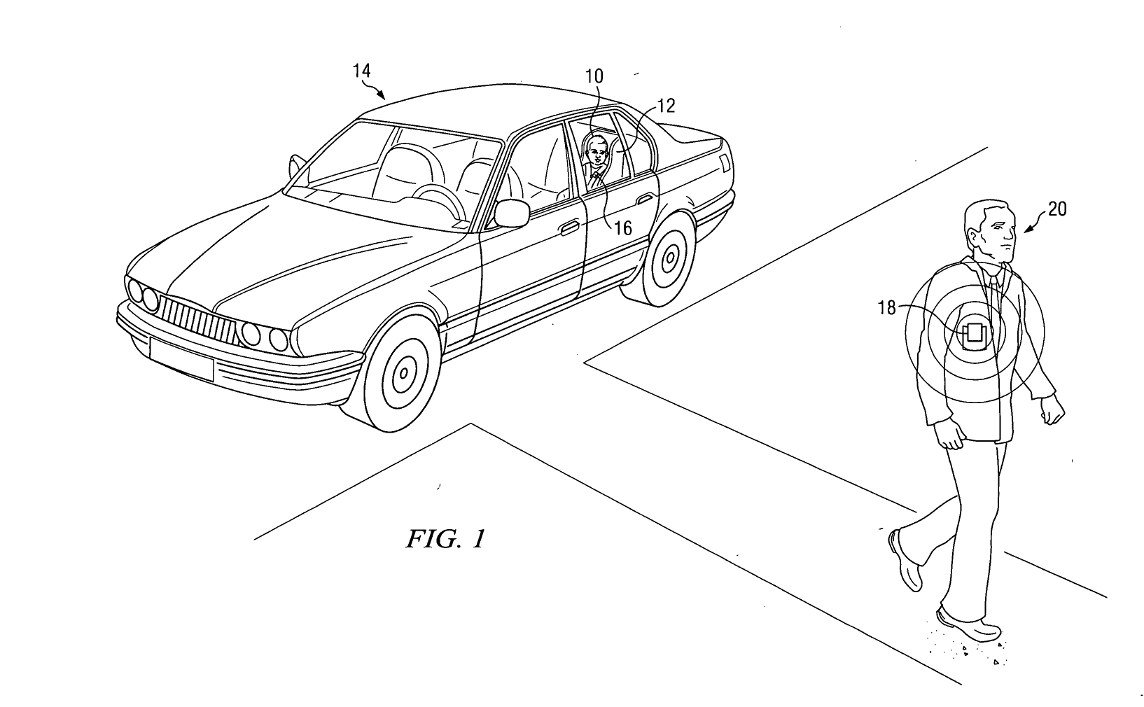

Referring now to the drawings, and in particularly to FIG. 1 thereof, there is shown a first utilization of the separation alert system of the present invention. An infant 10 is secured in a car seat 12 which is in turn secured in an automobile 14. A first component of the system of the present invention is shown secured to part of the car seat 12, it being understood that the component 16 can also be secured to the clothing of the infant 12 or to the structure of the automobile 14. A second component 18 of the system of the present invention is secured to the clothing of an adult 20 that is responsible or the safety of the infant 10.

Assume that the adult 20 leaves the infant 10 in the automobile 14 while running an errand or engaging in some other activity. As soon as the second component 18 of the system of the present invention is separated from the first component 16 thereof by more than a predetermined distance, the second component 18 is activated to produce an alarm thereby warning the adult 20 not to leave the infant 10. The alarm generated by the second component 18 may be audible, visible, or both. The alarm may also have a vibration mode. Preferably, the amount of separation between the first component and the second component of the system of the present invention which is necessary to activate the alarm is adjustable thereby allowing the adult 20 to move a short distance away from the infant 10 without triggering the alarm.

As will be appreciated by those skilled in the art, the present invention is capable of operating in a variety of modalities. By way of example only, the second component of the system of the present invention, that is, the component associated with a responsible adult, emits an inquiry signal at periodic intervals such as once every two seconds. If the first component of the system of the present invention, that is, the component which is secured to a child, an elderly or disabled person, or a pet or other animal requiring supervision is within range of the inquiry signal emitted by the first component, the second component emits a response signal. If the first component of the system receives a response signal from the first component, no alarm is sounded. However, should the second component of the system fail to receive a timely response signal from any first component of the system associated therewith, an alarm is sounded.

Regulation of the separation distance between the first and second components that triggers and alarm can be accomplished by regulating the intensity at which the response signal of the first component is emitted. By reducing the intensity of the response signal, the alarm is triggered at a closer distance, and vice versa.

In accordance with a second operational modality of the present invention the first component of the separation alert system emits a response signal on a continuous basis. The second component of the separation alert system is continuously actuated to receive the response signal from the first component thereof. Whenever the second component of the system does not receive the response signal from the first component for a predetermined period of time, an alarm is sounded. The degree of separation between the first component of the system and the second component thereof that is necessary to trigger an alarm can be varied by varying the intensity of the response signal emitted by the first component.

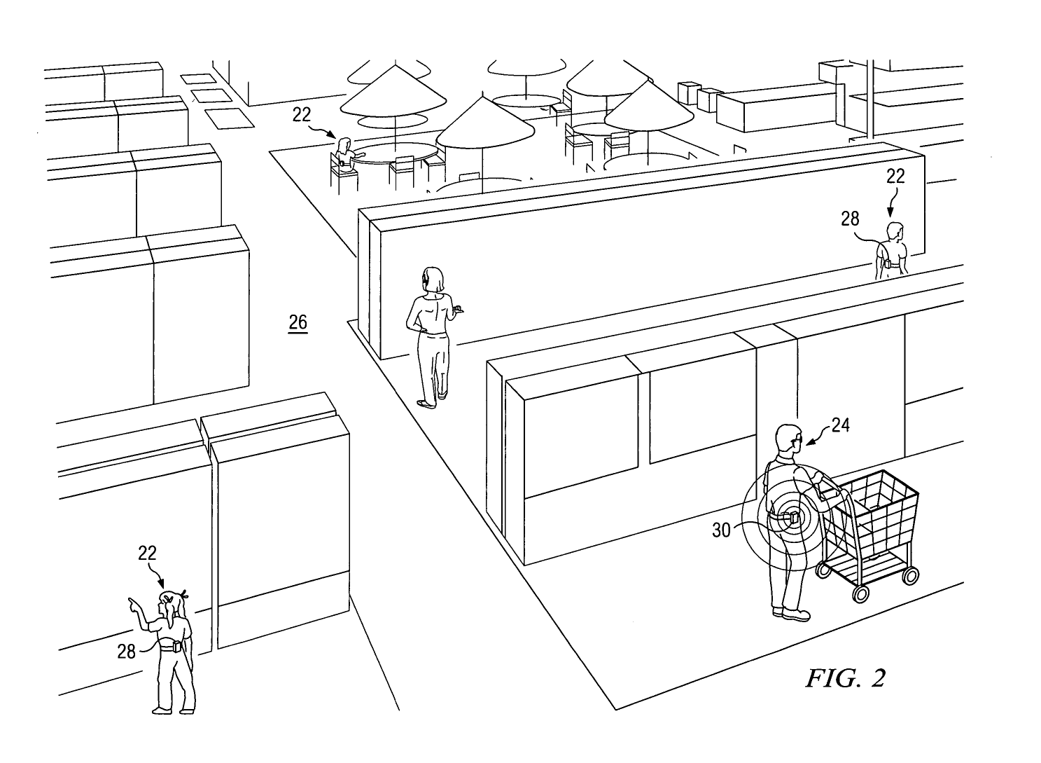

Referring to FIG. 2 a second utilization of the separation alert system of the present invention is diagrammatically illustrated. Several older children 22 and an adult 24 having responsibility for the children 22 visit a shopping facility 26, etc. A first component 28 of the system of the present is secured to a clothing item worn by each child 22, for example, a belt. A second component 30 of the system of the present invention is secured to a clothing item worn by the adult 24. Whenever any of the first components 28 and the second component 30 of the system of the present invention are separated by more than a predetermined distance, the second component 30 is activated to generate an alarm which is indicative of too much separation between one of the children 22 and the responsible adult 24. As will be readily understood, such separation can occur because the child is hiding, or because the child has become distracted during play, or because the child is simply lost.

The alarm which is activated when the second component 30 of the present invention is separated by more than a predetermined distance from any of the first components 28 thereof may be audible, visible, vibrating or any combination thereof. The alarm may include multiple, visible components including a signal light and a LED or liquid crystal display which shows the name associated with the particular first component of the invention that triggered the alarm. The audible component of the alarm may comprise a plurality of unique alarm tones each associated with an individual first component of the invention. Similarly, the vibratory component of the alarm may operate at different vibrational frequencies or sequences depending upon which of the first components triggered the alarm. Preferably the amount of separation between the components 28 and 30 that is necessary to activate the alarm is adjustable so that the adult 24 can move a predetermined distance away from the child 22 without activating the alarm.

It is also preferable that the second component 30 of the system of the present invention is capable of identifying which of the several first components 28 thereof triggered the alarm. This is accomplished by assigning a different frequency to each of the first components 28. The second component 30 generates inquiry signals which are sent to all of the first components 28 at periodic intervals, for example, every two seconds. When an individual first component 28 receives an inquiry signal, it generates a response signal at its assigned frequency. The second component 30 receives and responds to response signals at all of the frequencies assigned to the first components 28. If the second component 30 fails to receive a response signal from any of the first components 28, the second component 30 generates an alarm which is identified with the first component 28 from which a response signal was not received.

FIG. 2 illustrates the invention utilized at a shopping center. However, the invention is equally adapted for utilization at daycare facilities, schools, amusement parks, theme parks, theaters, etc.

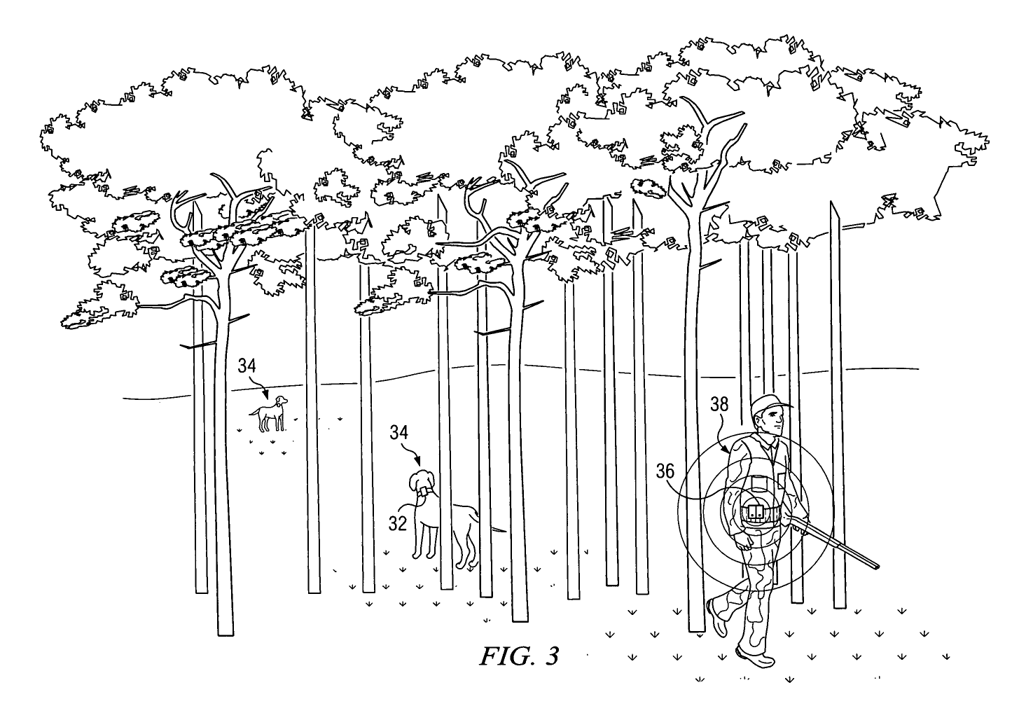

A third utilization of the separation alert system of the present invention is illustrated in FIG. 3. A first component 32 of the system of the present invention is secured to each of a plurality of animals 34 typically by attachment to a collar, harness, etc. worn by the animal. The second component 36 of the system of the present invention is secured to a clothing item worn by the master 38 of the animals 34. As is clearly shown in FIG. 3, the second component 36 is segregated into multiple sections each associated with one of the animals 34. In FIG. 3 the master 38 and the animals 34 are shown engaging in a hunting activity; however, it will be understood that the present invention is equally applicable to other activities involving the animals 34 and the master 38. For example, the invention can be utilized at dog kennels, etc.

Whenever a predetermined separation occurs between one of the first components 32 and the second component 36 of the system of the present invention, the second component 36 is activated to generate an alarm. The alarm may be either audible, visible, or both. Preferably, the amount of separation between the first components 32 and the second component 36 of the present invention which is necessary to activate the alarm is adjustable thereby allowing the animals 34 to have a certain amount of freedom of movement relative to the mater 38 without triggering the alarm.

When the separation alert system of the present invention is used with multiple animals, the first component of the system assigned to each animal operates at a different frequency as compared to the first components assigned to other animals. This allows the second component of the system to identify which of the animals has strayed in the manner described above.

Activation of the alarm comprising the second component of the system of the present invention notifies the master 38 that one or more of the animals 34 has strayed too far away. This allows the master 38 to initiate an appropriate action to bring the animal 34 back into closer proximity before the animal 34 has wandered so far away that recovery is either difficult or impossible. For example, the master 38 may utilize a voice command, a whistle, an electronic collar, or the master may simply begin searching for the animal 34 that has strayed.

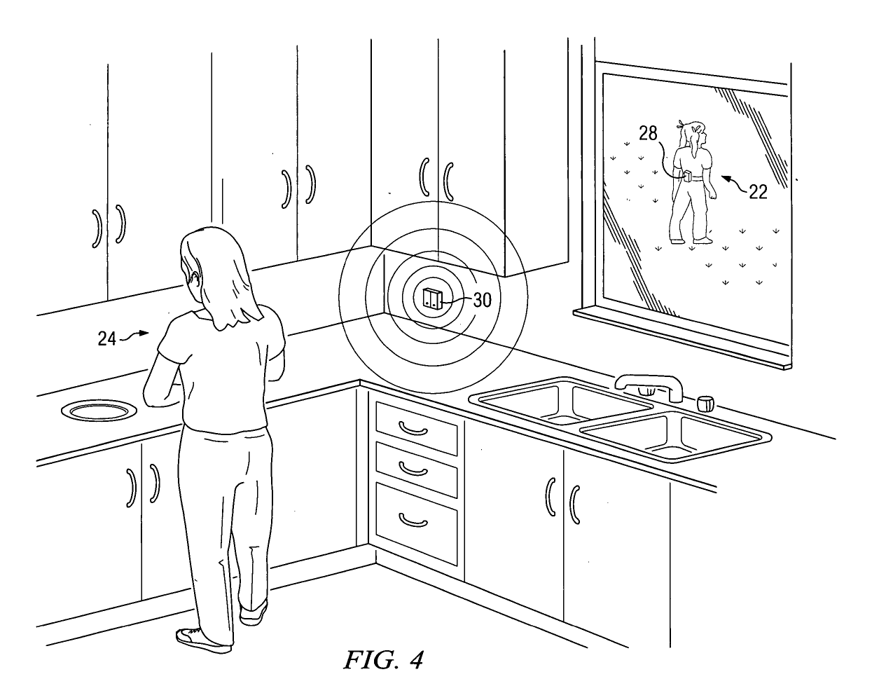

FIG. 4 illustrates a fourth utilization of the invention. The fourth utilization is similar in many respects to the second utilization thereof which is illustrated in FIG. 2 and described hereinabove in conjunction therewith. The component parts of the present invention are designated in FIG. 4 with the same reference numerals utilized in the description of the second utilization of the invention.

The fourth utilization of the invention is similar to the second utilization thereof in that one or more children 22 are each provided with a first component of the present invention which is secured to the child identified therewith by attachment to a clothing item, for example, a belt. The fourth utilization of the invention differs from the second utilization in that the second component 30 of the separation alert system of the present invention is not secured to a responsible adult, but is instead secured at a convenient location within a building, such as a home, in which the responsible adult 24 is working or otherwise engaged.

The second component 30 of the separation alert system is adapted to provide an audible signal having sufficient volume that it can be heard by the responsible adult 28 even though the responsible adult moves a significant distance away from the second component 30. In those circumstances in which multiple children 22 are being monitored simultaneously, the second component 30 of the present invention is adapted to generate a signal, either audible or visual, which identifies the particular child that has strayed too far for the response signal generated by the first component 28 to be recognized by the second component 30.

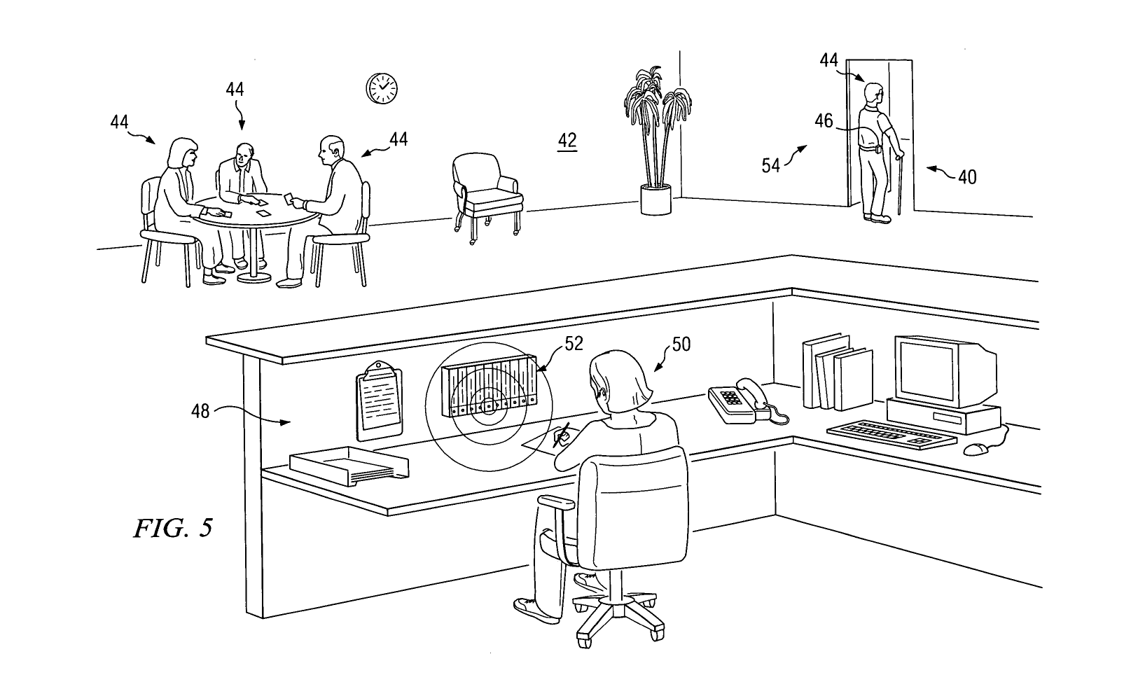

A fifth utilization of the invention is illustrated in FIG. 5. A nursing home, recreational center, or similar facility 40 includes a secure area 42. The secure area 42 is illustrated in FIG. 5 as comprising a room, however, the secure area 42 may comprise multiple rooms, an entire building, an indoor/outdoor facility, or a facility located entirely outdoors.

A plurality of elderly or disabled individuals 44 are temporarily confined to the secure area 42 in order to assure their safety, and to facilitate the provision or medical or other aid should circumstances warrant. Each of the individuals 44 is provided with a first component 46 comprising the present invention. Each first component 46 is secured to a clothing item worn by one of the individuals 44. Each first component 46 has a different response signal frequency assigned thereto.

The secure area 42 includes a workstation 48. One or more responsible adults 50 are constantly present at the workstation 48 in order to be available to provide assistance to the individuals 44 on an as needed basis. A second component 52 of the present invention is located at the workstation 48 for ready access by one or more responsible adults 50 located therein. The second component 52 receives response signals from all of the first components 46 which are secured to the individuals 44. As indicated at 54, one of the individuals 44 may attempt to leave the secure area 42. In such instances the second component 52 generates an alarm signals which is specifically identified with the particular individual 44 that has left the secure area 42.

Activation of the alarm comprising the second component 52 of the system of the present invention notifies the responsible adult 50 that one or more of the individuals 44 has strayed out of the secure area 42. This allows the responsible adult 50 to initiate an appropriate action to return the individual 44 back into the secure area 42.

Although preferred embodiments of the invention have been illustrated in the accompanying Drawing and described in the foregoing Detailed Description, it will be understood that the invention is not limited to the embodiments disclosed but is capable of numerous rearrangements, modifications, and substitutions of parts and elements without departing from the spirit of the invention.

1. A separation alert system comprising:
a first component securable to a person;
a second component securable to a person responsible for the person having the first component secured thereto;
the second component comprising means for generating an alarm; and
means for actuating the alarm when the second component is separated from the first component by more than a predetermined distance.

2. A separation alert system according to claim 1 further including a plurality of first components each secured to a different person, and wherein the alarm actuating means actuates the alarm whenever the second component is separated from any of the first components by more than a predetermined distance.

3. A separation alert system according to claim 2 wherein the first components communicate with the second component electronically, and wherein each of the first components have an electronic frequency associated therewith which is different from the electronic frequencies associated with the remaining first components.

4. The separation alert system according to claim 3 wherein the second component emits inquiry signals at periodic intervals, wherein each of the second components emits a response signal in response to receipt of the inquiry signal from the second component, and wherein the alarm actuating means is responsive to non-receipt of the response signal from any of the first components for actuating the alarm.

5. The separation alert system according to claim 3 wherein each of the first components continuously generates an electronic signal at the electronic frequencies associated therewith, wherein the second component continuously monitors the electronic signals generated by the first components, and wherein the alarm actuating means is responsive to non-receipt of the electronic signal generated by any of the first components by the second component.

6. A separation alert system comprising:
a first component securable to an animal;
a second component securable to a person responsible for the animal having the first component secured thereto;
the second component comprising means for generating an alarm; and
means for actuating the alarm when the second component is separated from the first component by more than a predetermined distance.

7. A separation alert system according to claim 6 further including a plurality of first components each secured to a different person, and wherein the alarm actuating means actuates the alarm whenever the second component is separated from any of the first components by more than a predetermined distance.

8. A separation alert system according to claim 7 wherein the first components communicate with the second component electronically, and wherein each of the first components have an electronic frequency associated therewith which is different from the electronic frequencies associated with the remaining first components.

9. The separation alert system according to claim 8 wherein the second component emits inquiry signals at periodic intervals, wherein each of the second components emits a response signal in response to receipt of the inquiry signal from the second component, and wherein the alarm actuating means is responsive to non-receipt of the response signal from any of the first components for actuating the alarm.

10. The separation alert system according to claim 8 wherein each of the first components continuously generates an electronic signal at the electronic frequencies associated therewith, wherein the second component continuously monitors the electronic signals generated by the first components, and wherein the alarm actuating means is responsive to non-receipt of the electronic signal generated by any of the first components by the second component.
